(19) United States
(12) Patent Application Publication
(10) Pub. No.: US 2022/0115882 A1
(43) Pub. Date: Apr. 14, 2022

(54) MODULAR POWER SYSTEMS

(71) Applicant: REGRID ENERGY LLC, Edmond, OK (US)

(72) Inventor: Shawn Clark, Edmond, OK (US)

(21) Appl. No.: 17/499,811

(22) Filed: Oct. 12, 2021

Related U.S. Application Data
(60) Provisional application No. 63/089,654, filed on Oct. 9, 2020.

(51) Int. Cl. H02J 7/00; H01M 10/46; H01M 10/04; H01M 10/48

(52) U.S. Cl. CPC H02J 7/0044; H02J 7/0045; H02J 7/0048; H01M 10/052; H01M 10/0422; H01M 10/486; H01M 10/46

(57) ABSTRACT

A versatile, modular power source is described which can be used as a worker pod to provide power to a portable device, to a residential/commercial power wall, or to a grid. The versatile, modular power source is designed to be replaceable and interchangeable to provide power to a variety of different targets.

This application claims priority to U.S. Provisional Patent Application Ser. No. 63/089,654, filed on Oct. 9, 2020, the contents of which are hereby incorporated by reference herein in their entirety into this disclosure.

### BACKGROUND OF THE SUBJECT DISCLOSURE

### Field of the Subject Disclosure

The present subject disclosure relates to power sources. More specifically, the present subject disclosure relates to modular power sources which are stackable to provide power to any desired target.

### Background of the Subject Disclosure

Harnessing power is one of the greatest feats of human engineering. To be able to capture, store, and release power at will has allowed a transformation of how humans in modern times live and survive. Further, virtually everything humans use daily needs some sort of power source, whether it is through natural resources (coal, sun, water, wind), or human created (nuclear, etc.). Conventionally, power is provided to the consumer through either AC (inside home or businesses) or DC (through a stored battery).

As ubiquitous as power is, there is virtually no single base source of power which is applicable to all targets of power. For example, the power source needed to charge a mobile phone is often different than the power source needed to jump start an automobile, which is again different than the power source needed to provide electricity to a residence or a business. Finally, the power source needed to provide power to an electrical grid for a geographic location is again vastly different than the other listed power sources.

The need to provide different modes of manufacture to create, support, repair, replace, regenerate, and recycle the different sources of power leads to inefficiencies in the system, higher costs to consumers, and more detrimental long term environmental impact.

### SUMMARY OF THE SUBJECT DISCLOSURE

The present subject disclosure describes a power source unit which is compact, versatile, and modular. This power source unit may be the base power source unit used to power small devices, automobiles, an entire home or business, and even a town or city. The versatility of the subject disclosure allows universal adoption and implementation worldwide, allowing the setup and use of power within days, rather than weeks or months as in standard power sources.

In one exemplary embodiment, the present subject disclosure is a power source. The power source includes a housing having an interior and an exterior; a plurality of batteries positioned within the interior of the housing; a power port positioned on the exterior of the housing and used to derive power from the batteries to power an individual device; and a connection port positioned on the exterior of the housing and used to provide power to an additive power source.

In another exemplary embodiment, the present subject disclosure is a portable power source. The portable power source includes a portable shell having an input chamber for receiving a modular power source, wherein the modular power source comprises: a housing; and a plurality of batteries positioned within the housing; a power port positioned on the shell and used to provide power from the modular power source.

In yet another exemplary embodiment, the present subject disclosure is a power source. The power source includes a stationary receiving device having a plurality of input chambers for receiving a plurality of modular power sources, wherein the modular power source comprises: a housing; and a plurality of batteries positioned within the housing; a power port positioned on the stationary receiving device and used to provide cumulative power from the plurality of modular power sources.

### BRIEF DESCRIPTION OF THE DRAWINGS

FIG. 1A shows a side perspective view of a single pod power source, according to an exemplary embodiment of the present subject disclosure.

FIG. 1B shows a side perspective view of a single pod power source in various applications, according to an exemplary embodiment of the present subject disclosure.

FIG. 2A shows a side perspective view of a single pod power source incorporated into various platforms, according to an exemplary embodiment of the present subject disclosure.

FIG. 2B shows a side perspective view of a single pod power source generating different magnitudes of power, according to an exemplary embodiment of the present subject disclosure.

FIG. 3A shows a front side perspective view of a single pod power source, according to an exemplary embodiment of the present subject disclosure.

FIG. 3B shows a back side perspective view of a single pod power source, according to an exemplary embodiment of the present subject disclosure.

FIG. 3C shows a side perspective view of an internal battery array set up for a single pod power source, according to an exemplary embodiment of the present subject disclosure.

FIG. 4A shows an exploded side perspective view of a single pod power source, according to an exemplary embodiment of the present subject disclosure.

FIG. 4B shows an exploded bottom perspective view of a single pod power source, according to an exemplary embodiment of the present subject disclosure.

FIG. 5 shows a side perspective view of a portable multi-pod power source, according to an exemplary embodiment of the present subject disclosure.

FIG. 6A shows a side perspective view of a small stationary home/commercial multi-pod power source, according to an exemplary embodiment of the present subject disclosure.

FIG. 6B shows a side perspective view of a large stationary home/commercial multi-pod power source, according to an exemplary embodiment of the present subject disclosure.

FIG. 6C shows another side perspective view of a large stationary home/commercial multi-pod power source, according to an exemplary embodiment of the present subject disclosure.

FIG. 7 shows a perspective view of a large stationary building multi-pod power source, according to an exemplary embodiment of the present subject disclosure.

FIG. 8A shows a side perspective view of a single pod power source, according to an exemplary embodiment of the present subject disclosure.

FIG. 8B shows a side perspective view of a single pod power source with a shadow view of internal components, according to an exemplary embodiment of the present subject disclosure.

FIG. 9A shows a side view of a single pod power source, according to an exemplary embodiment of the present subject disclosure.

FIG. 9B shows a side view of a single pod power source with a shadow view of internal components, according to an exemplary embodiment of the present subject disclosure.

FIG. 10A shows a top view of a single pod power source, according to an exemplary embodiment of the present subject disclosure.

FIG. 10B shows a top view of a single pod power source with a shadow view of internal components, according to an exemplary embodiment of the present subject disclosure.

FIG. 11A shows a bottom view of a single pod power source, according to an exemplary embodiment of the present subject disclosure.

FIG. 11B shows a bottom view of a single pod power source with a shadow view of internal components, according to an exemplary embodiment of the present subject disclosure.

FIG. 12 shows an exploded side perspective view of a single pod power source with pod receptacle, according to an exemplary embodiment of the present subject disclosure.

FIG. 13A shows a side perspective view of a pod receptacle, according to an exemplary embodiment of the present subject disclosure.

FIG. 13B shows a top view of a pod receptacle, according to an exemplary embodiment of the present subject disclosure.

FIG. 13C shows a front view of a pod receptacle, according to an exemplary embodiment of the present subject disclosure.

FIG. 13D shows a side view of a pod receptacle, according to an exemplary embodiment of the present subject disclosure.

FIG. 14A shows a side perspective view of a pod interface, according to an exemplary embodiment of the present subject disclosure.

FIG. 14B shows a bottom view of a pod interface, according to an exemplary embodiment of the present subject disclosure.

FIG. 15A shows a side perspective view of an electronics connection, according to an exemplary embodiment of the present subject disclosure.

FIG. 15B shows a closeup side perspective view of an electronics connection, according to an exemplary embodiment of the present subject disclosure.

FIG. 15C shows a front view of electronics connections, according to an exemplary embodiment of the present subject disclosure.

FIG. 16 shows a schematic view of system integration, according to an exemplary embodiment of the present subject disclosure.

FIG. 17 shows another schematic view of system integration, according to an exemplary embodiment of the present subject disclosure.

FIG. 18A shows a side perspective view of an array of hexagonal multi-drawer power cabinets, according to an exemplary embodiment of the present subject disclosure.

FIG. 18B shows a front view of a hexagonal multi-drawer power cabinet, according to an exemplary embodiment of the present subject disclosure.

FIG. 18C shows a side perspective view of a hexagonal multi-drawer power cabinet, according to an exemplary embodiment of the present subject disclosure.

FIG. 18D shows a top down view of an open drawer in a hexagonal multi-drawer power cabinet, according to an exemplary embodiment of the present subject disclosure.

FIG. 19A shows a side perspective view of a multi-drawer power cabinet, according to an exemplary embodiment of the present subject disclosure.

FIG. 19B shows a side view of a multi-drawer power cabinet, according to an exemplary embodiment of the present subject disclosure.

FIG. 19C shows a front view of a multi-drawer power cabinet, according to an exemplary embodiment of the present subject disclosure.

FIG. 19D shows a top down view of an open drawer in a multi-drawer power cabinet, according to an exemplary embodiment of the present subject disclosure.

FIG. 20A shows a side perspective view of an arrangement tray, according to an exemplary embodiment of the present subject disclosure.

FIG. 20B shows a top view of an arrangement tray, according to an exemplary embodiment of the present subject disclosure.

FIG. 20C shows a side view of an arrangement tray, according to an exemplary embodiment of the present subject disclosure.

FIG. 21 shows a top view of another arrangement tray, according to an exemplary embodiment of the present subject disclosure.

FIG. 22A shows a side perspective view of a first power container, according to an exemplary embodiment of the present subject disclosure.

FIG. 22B shows a top view of a first power container, according to an exemplary embodiment of the present subject disclosure.

FIG. 23A shows a side perspective view of a second power container, according to an exemplary embodiment of the present subject disclosure.

FIG. 23B shows a top view of a second power container, according to an exemplary embodiment of the present subject disclosure.

FIG. 24A shows a side perspective view of a third power container, according to an exemplary embodiment of the present subject disclosure.

FIG. 24B shows a top view of a third power container, according to an exemplary embodiment of the present subject disclosure.

FIG. 25A shows a side perspective view of power containers of various sizes, according to an exemplary embodiment of the present subject disclosure.

FIG. 25B shows a side perspective view of a stacked series of power containers, according to an exemplary embodiment of the present subject disclosure.

### DETAILED DESCRIPTION OF THE SUBJECT DISCLOSURE

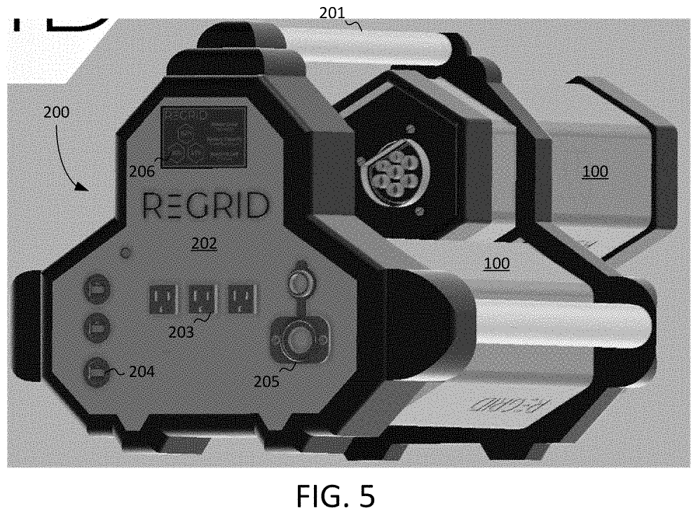

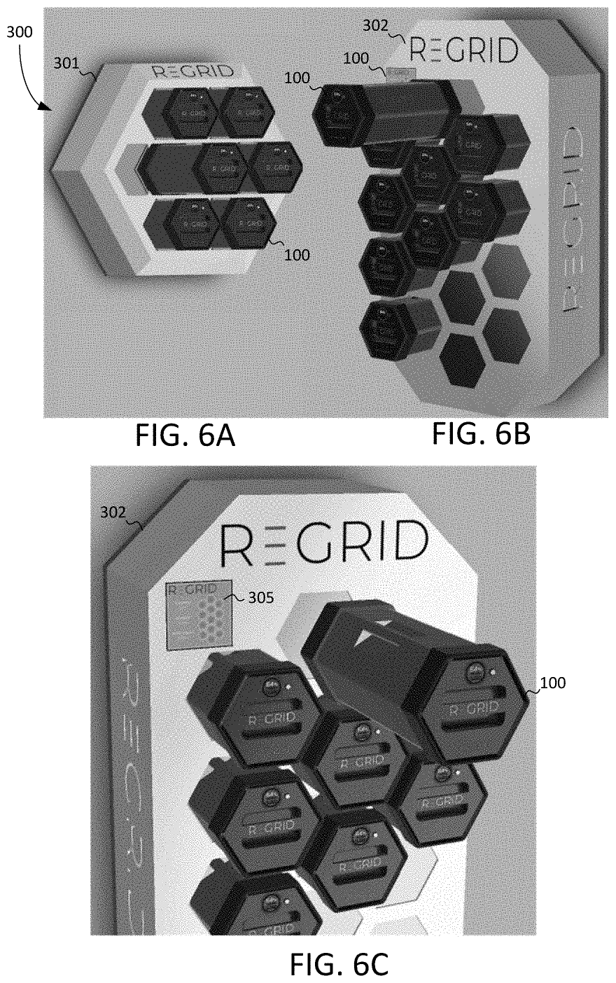

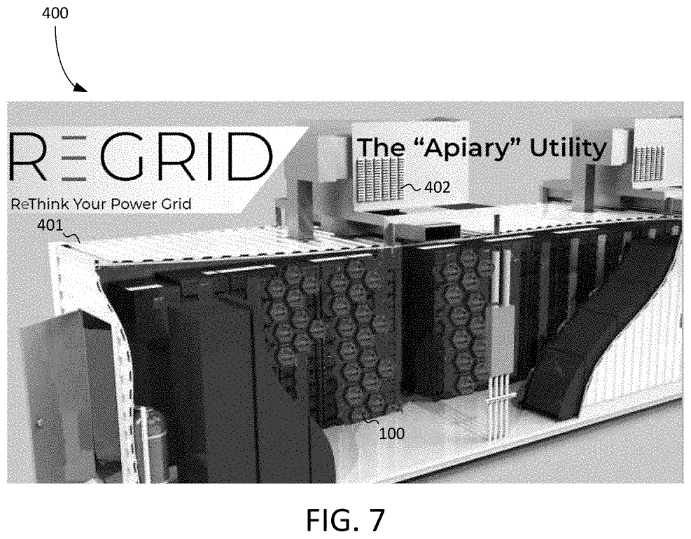

The present subject disclosure addresses the burden of having to have different sources of power depending on the need, and the inefficiencies, costs, and environmental impact of needing such different sources. The present disclosure presents a single working unit, herein named a “pod,” which stores a plurality of power cell sources, and is designed to be a single size, and easily replaceable. In one exemplary embodiment, one or more pods may be input into a single portable unit, herein named a “comb” (e.g., FIG. 5), and used primarily to provide transportable power to any device needing power. In another exemplary embodiment, one or more pods may be input into a single stationary unit, herein named a “hive” (e.g., FIGS. 6A-6C), and used primarily to provide power to residential or commercial locations. In yet another exemplary embodiment, one or more pods may be input into a single stationary unit, herein named as “apiary” (e.g., FIG. 7), and used primarily to provide power to power grids, such as for municipalities, towns, cities, etc.

One of the many unique aspects of the present subject disclosure is the use of the same core worker pod to provide power to any source in need of power, from simple small electrical devices, such as mobile telephones, to an entire city power grid. Conceivably, all devices, systems and tools within a city would have the same common denominator, which is the “worker pod” as shown and described herein. This worker pod would be the basic element used for all power sources. Thus, this would result in greater efficiencies in the power system, lower costs to consumers, and much lower long term environmental impact since the individual pods could then be easily serviced, remanufactured, repaired, and replaced.

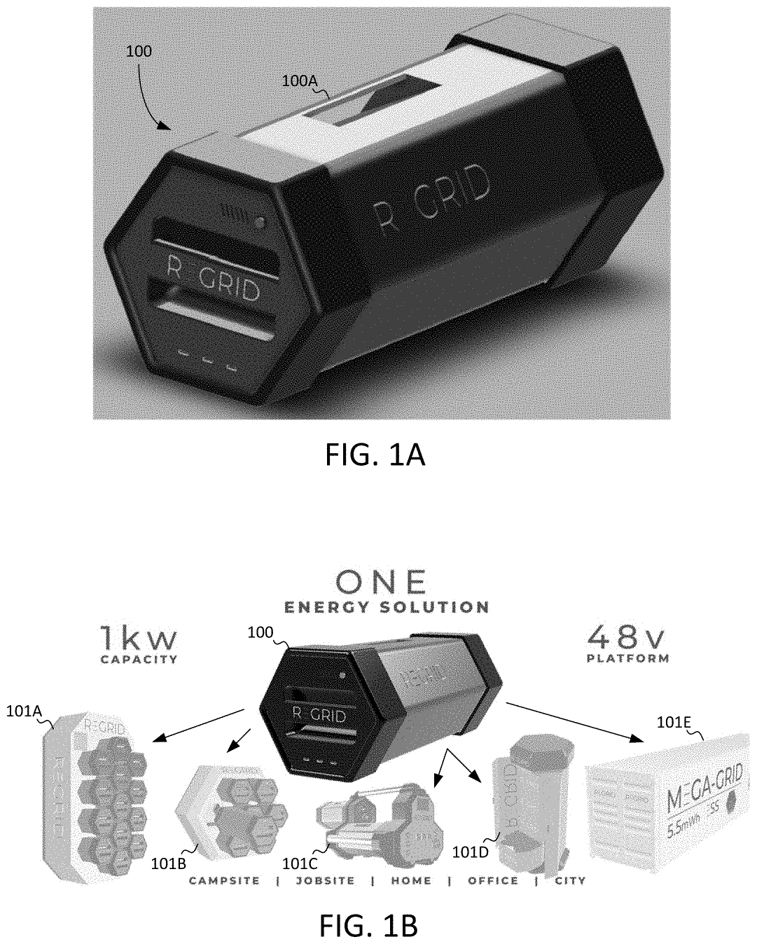

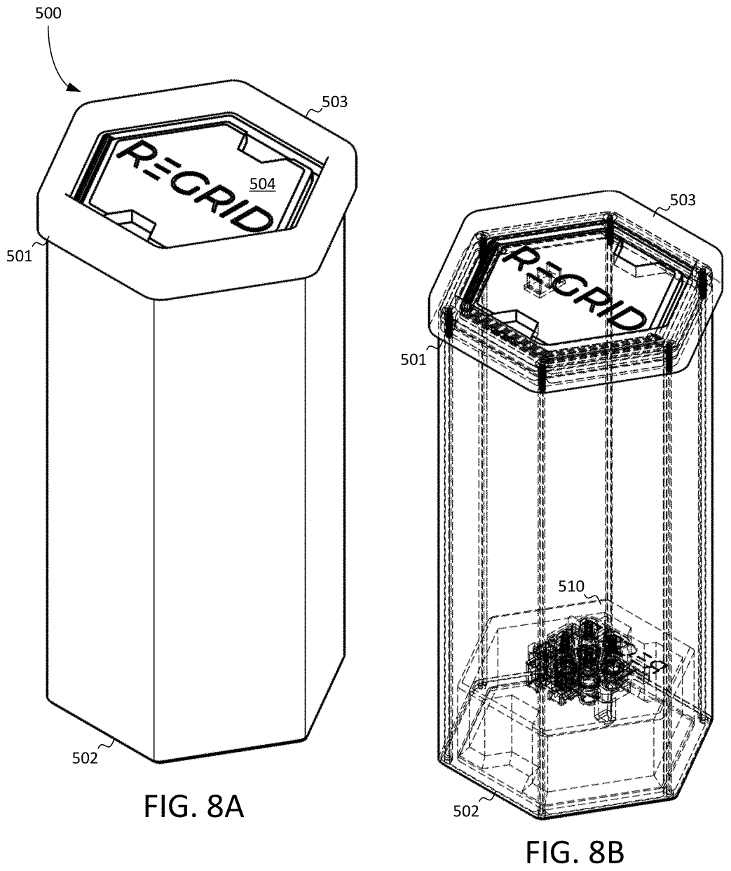

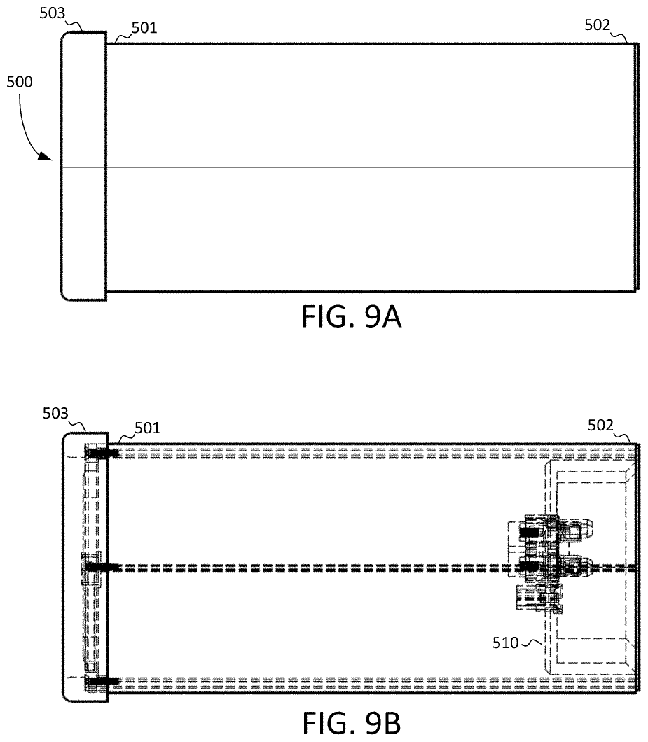

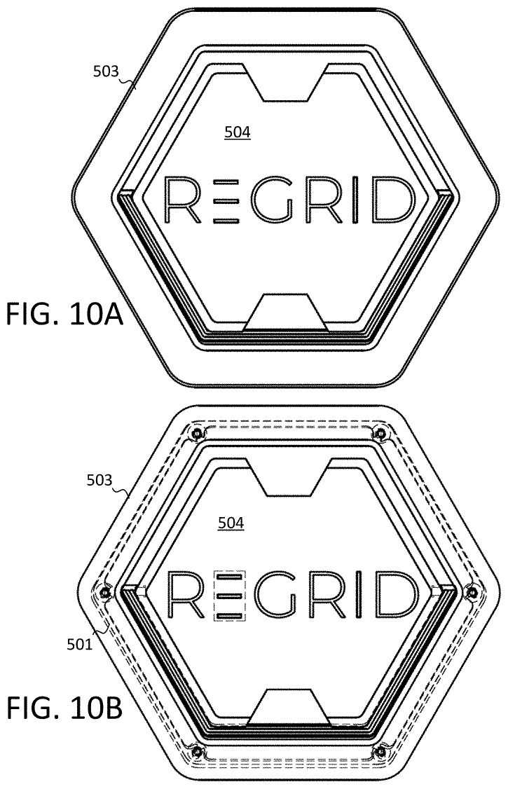

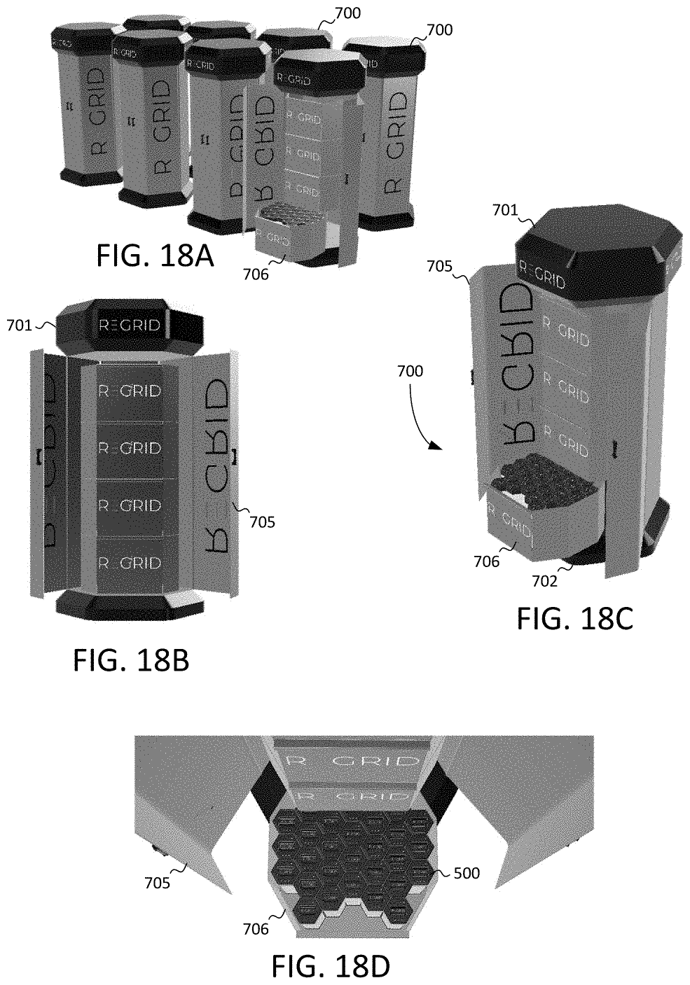

As shown and described herein, FIGS. 1-7 provide an overview of a worker pod and its major components, along with various platforms it may be used within. FIGS. 8-17 provide more detail and description of a particular example of a single unit of a worker pod. Finally, FIGS. 18-25 provide specific examples of the use of the worker pod in various arrays to generate larger magnitudes of power. It should be noted that any feature or component described in one figure or embodiment may be substituted into another figure or embodiment, as would be appreciated by one having ordinary skill in the art. Not every combination of features has been presented for sake of simplicity, but any such combination or one or more features described herein for a given embodiment is readily substitutable into any other embodiment.

FIG. 1A shows a perspective view of an exemplary embodiment of a single power source unit as a worker pod 100, according to the present disclosure. This worker pod 100 is the basic building block for the various embodiments which will be shown and described in more detail below. The worker pod 100 is designed to be lightweight and portable, and may include one or more ergonomic handles 100A positioned centrally on a long axis on any of the outer surfaces, to ease its portability.

This “worker” energy storage pod 100 is the core of the present subject disclosure. In some examples, it has a 1 kW, 48V stored energy lithium battery. As shown in FIG. 1B, the worker pod 100 is modular and interchangeable with other worker pods 100 in devices and systems set up in any environment. Shown as mere examples in FIG. 1B are larger array 101A (containing up to 13 pods), smaller array 101B (containing up to 7 pods), a portable carrier 101C (containing 1-3 pods), a tray shelf system 101D (containing up to 100 or more pods), and large power systems (containing up to 1000 or more pods). This variety of applications allows the single pod 100 to be the base unit of power in any location including, but not limited to, campsites, jobsites, home, office, town/city.

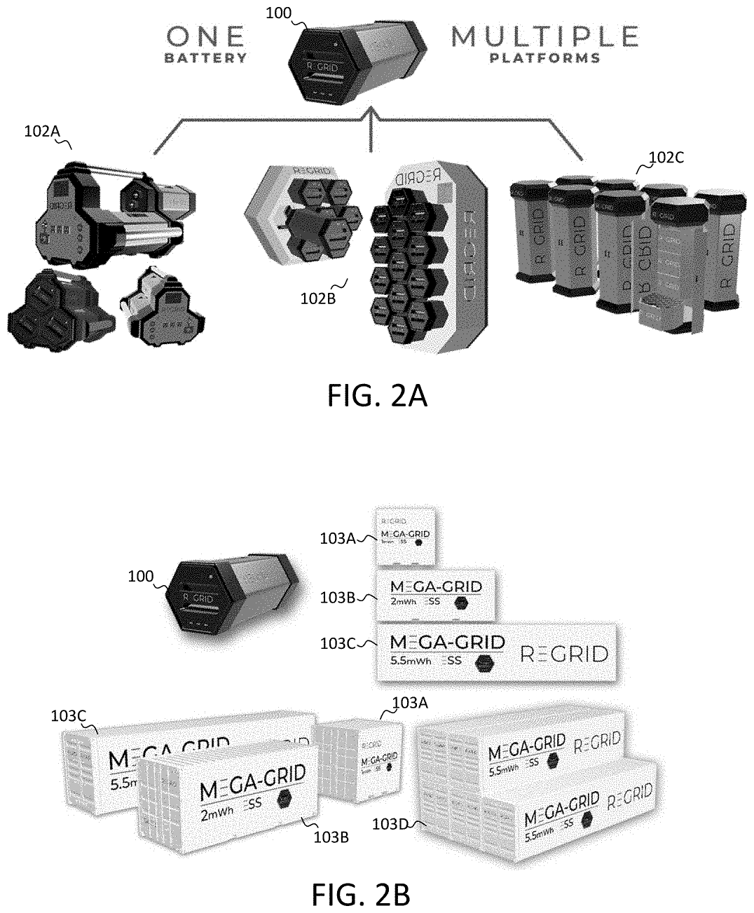

FIG. 2A shows that the single power unit pod 100 may be the basis for any type of platform, whether in use for portable devices 102A (e.g., 1-3 pods), smaller fixed locations 102B (e.g., 1-13 pods; for home or office use), or larger fixed locations (e.g., hundreds or thousands of pods; for large businesses, or town/municipalities).

The single pod 100 may be used alone (for example in a portable device 102A) or may be scaled with hundreds or even thousands of other pods 100 to create a grid. As shown in FIG. 2B, one thousand (1000) pods 100 may be grouped together to create a 1 MW grid 103A. Two thousand (2000) pods 100 may be grouped together to create a 2 MW grid 103B. Five thousand five hundred (5500) may be grouped together to create a 5.5 MW grid. The exemplary individual grids 103A, 103B, and 103C are efficiently packed together to minimize footprint in a given location. The individual grids 103A, 103B, 103C are stackable, expandable, and customizable. Any number of pods may be used to create a desired MW outcome.

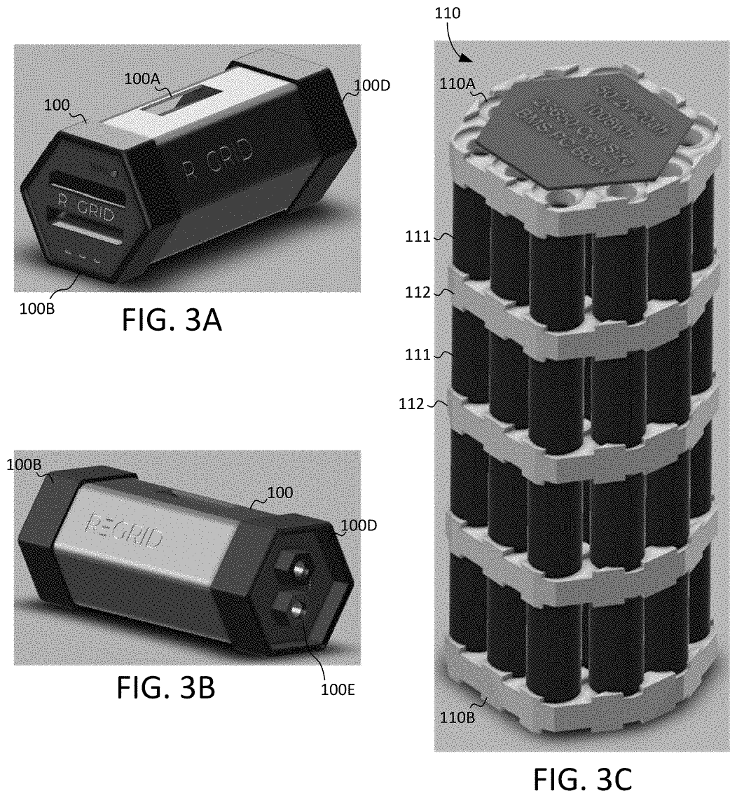

As described herein, the single pod 100 is designed to fit within all other components from portable, home, office/commercial, to utility scale microgrid energy storage. As shown in FIGS. 3A-3B, the worker pod 100 has a front portion 100B that may include various output ports including, but not limited to, USB ports, and others. A rear portion 100D of the worker pod 100 may contain positive/negative female input ports 100E which connect with complementing male ports in a corresponding unit. Other types of connectors on the rear portion 100D are possible, and will be shown and described in subsequent embodiments below.

An example of a worker pod 100 is a 50.4 V, 20 Ah. Other variations are also possible and within the purview of the present disclosure. Exemplary specifications, dimensions, and tolerances of a worker pod 100 are shown and presented in TABLE 1, which is merely an example, and is not limiting of the type of battery to be used.

TABLE 1
BATTERY PACK SPECIFICATION

| | |
|---|---|
| Commodity | 52 V 20 Ah battery pack |
| Model | PVC |
| Typical voltage | 52 V |
| Nominal Capacity | 20 Ah |
| Weight | 6.0 Kg |
| Cell spec | 18650-2600 mAh |
| Pack assemble | 8P14S |
| Charging (23 ± 2° C.) | 5AConstant current to 58.8 V, then constant voltage |
| | charge to current drop to 300 mA to cut off. |
| Discharge (23 ± 2° C.) | 10 A constant current discharge to 39.2 V |
| Cycle life | Standard charge and discharge with 300 |
| | cycles, battery pack capacity keeps more than 80% |
| Max continuous charge current | 5 A |
| Max continuous discharge current | 30 A |
| Max burst discharge current | 100 A |
| Battery pack impedance | <220 mΩ at typical voltage |
| Case | battery size: Max: L: 320 mm |
| Charge and discharge at same | Silica wire-200 mm, red positive terminal, black |
| terminal | negative terminal |
| 5 V output | 3 TYPE USB-C |
| [symbol] | [symbol] (14S30A [symbol] ) |
| Battery fuel guage | % display |
| Storage condition | Temperature : 15 −+ 35 ° C., humidity : 45-75%, |
| | Pressure : 86-106 KPa |
| Working temperature | charge : 0-45 ° C. discharge : −20-60 ° C. |

The worker pod 100 is shown in the examples as having a hexagonal shape, but any shape may be used. One of ordinary skill in the art would appreciate that the design shown is merely exemplary, and that various other configurations, shapes, specifications, and architecture may be used for the worker pod, and still be within the purview of the present subject disclosure.

In one non-limiting exemplary embodiment, the worker pod 100 includes:
Cell Type: Lithium NMC (Nickel Manganese Cobalt Oxide)
Cell Spec: 3.6 v 2.5 ah 18650 Cell
Pack Construction: 8 P 14 S
Pack Spec: 50.4 v 20 ah 1008 wh

In another exemplary embodiment, a different construction will require using a 26650 size cell instead of the 18650. The specifics are as follows:
Cell Type: Lithium NMC (Nickel Manganese Cobalt Oxide)
Cell Spec: 3.6 v 5 ah 22650 Cell
Pack Construction: 4 P 14 S
Pack Spec: 50.4 v 20 ah 1008 wh

As shown in TABLE 1, a cell spec range of 18650-2600 mAh is listed as an example. Different cell constructions can be used which result in different ranges. 18651-2600 mAh is 8 P 14 S. 26650-5000 mAh is 4 P 14 S. Other variations are also possible, and within the scope of the present disclosure.

FIG. 3C shows an exemplary internal battery array portion 110 of a worker pod 100. A sequential sequence of an array of batteries 111 separated by spacers 112 are contained by an upper spacer 110A and a lower spacer 110B, acting as bookends.

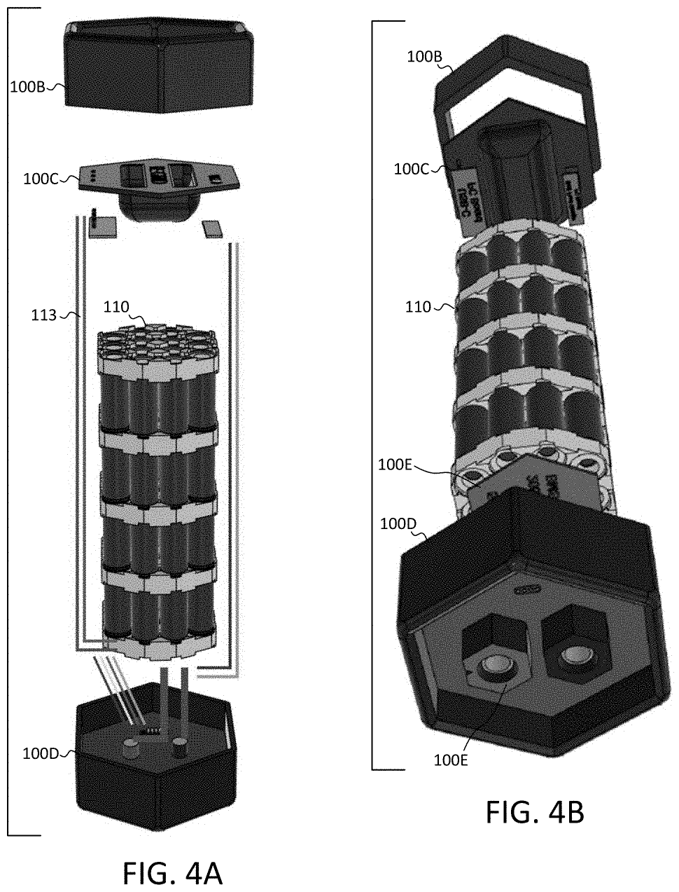

As shown in more detail in the exploded figures of FIGS. 4A-4B, a worker pod 100 has a front portion 100B, an interface portion 100C, and a rear portion 100D, which serve to enclose a battery array portion 110. A PC board 100E may be positioned near the rear portion 100D. Various wiring 113 interconnect the components. TABLE 2 contains an exemplary list of battery cell construction & PC board specifications. This is an example only, and the present disclosure is not limited to this example.

TABLE 2
BATTERY CELL CONSTRUCTION & PC BOARD SPECS

Construction:
Positive & Negative Out
AWG
Communication Requirements:
Cycle Times
Temp
Battery Capacity
Real Time Wattage Draw
To Handle Cap:
QI Charge ability to USB-C
5-Blue Diodes with Push Button Quick Capacity Check
Also Light up while charging at current capacity level
Specs & Performance:
Nominal voltage: 50.4 v
Typical capacity: 20 ah
Min. Capacity: 20 Ah
Cell: 3.6 v-5000 mah-26650-14s4p-1008 wh
BMS: 14S20A
Max continuous discharge current: 25 A
Discharge cut-o_ voltage: 37.5 v
Charge input voltage: 54.75 V
Charge current: _10 A
Size (L*W*H) ???

As shown in FIG. 5, one, two, or three worker pods 100 may be inserted into a portable device 200 to allow easy transport of power to any location. The “comb” portable device 200 has insertion slots for up to three individual unit pods 100. A handle 201 allows for the easy handling of the portable device 200. The front portion 202 of the portable device 200 has a number of features which aid in the delivery of the power stored in the individual unit pods 100. For example, AC outlets 203, USB ports 204, and a cigarette lighter port 205 are a few examples of power outlets which may be located on the front 202 of the portable power device 200. The same outlets 203, 204, 205 may also be used to power or charge the individual pods 100, as explained below.

As described above, FIG. 5 shows an exemplary embodiment of a portable power device 200. The portable device 200 will receive one or more worker pods 100, and invert that stored DC battery power, and output 120 volts of AC power. Multiple models are possible. Two non-limiting exemplary embodiments include: (1) 500 w inverter that accepts 1 worker pod (not shown); (2) 3000 w inverter that accepts 3 worker pods (shown in FIG. 5). Various features may be included in the comb portable device 200 including, but not limited to, solar charging inputs, USB 204, WIFI/Bluetooth, and a reporting screen 206 showing the electrical status. Another screen can show the functioning of each of the worker pods to indicate if one is weak or inoperable. Thus, the user can simply swap out the weak or inoperable worker pod with another functioning one. A smaller version of the portable device 200 can be used for the camper, the boater, for backup emergency power, or for the light duty electronics user. A 3000 w version of the portable device 200 can be used for a construction job site or heavy user.

Exemplary specifications, dimensions, and tolerances of the comb portable device 200 are shown and presented in TABLE 3.

TABLE 3
PORTABLE POWER DEVICE SPECS

| | |
|---|---|
| POWER OUTPUT SPECS | COMB-3k (Three Worker Pod |
| COMB-1k (Single Worker Pod | Attachment) |
| Attachment) | |
| AC inverter (output, pure sine wave): | AC inverter (output, pure sine wave): |
| 120 VAC 60 HZ | 120 VAC 60 Hz |
| 1000 W/2000 W Surge | 3000 W/6000 W Surge |

Feature Description on both Models (Comb-1k & Comb-3k:
1, LCD Display: (1) Over-load Alarm
(2) SOC Display (5 steps)
(3) Remain Capacity Display (Battery Remain Capacity)
(4) USB Output Display(On/Off)
(5) Type C Output Display(On/Off)
(6) DC Output Display(On/Off)
(7) AC Output Display(On/Off)
(8) Power Consumption Display (Inverter Real Output
Power)
2, DC/DC Part: (1) 24 V Input - 12 V Output >20 A
(2) 24 V Input 5 V Output >9 A (Phone Charging)
3, Charging Part: (1) 24 V DC Input Port
(2) Solar Charging Input Port
4, Pure Sine Wave Inverter : 24 V Input - 120 V Output, >800 W Power
5, Communication: (1) RS485
(2) CANBus
(3) RS232
(4) i2c Data Sampling
6, 3 Channel 12 V Output: (1) 12 V Cigarette Output
(2) 12 VDC Output 10 A
(3) 12 VDC Output 10 A
7, 3 Channel 5 V Output: (1) USB Output 2.1 A 2 Channels (<2.1 A Charge
Current)
(2) Type C Output 2.6 A
(3) USB Output 3 A (Fast Charging)
8, LED Spot Light: 24 V LED (>3 W)
9, Data Output: Bluetooth APP
10, ON/OFF Switch: to control the power of the whole unit
11, Power Switch: (1) 12 Vdc Output On/Off Switch
(2) 120 VAC Output On/Off Switch
(3) 5 VDC Output On/Off Switch
12, Bluetooth Function Description:
Control: (1), General ON/OFF Switch (including battery & inverter)
(2), Open/Shut-down 5 Vdc Output
(3), Open/Shut-down 12 Vdc Output
(4), Open/Shut-down 120 Vac Output
(5), Open/Shut-down LED Lighting Output
Data Output: (1) Send Inverter data
(2) Send Battery data
(3) Status of the whole unit, Including alarm, On/Off
Switch status.

FIGS. 6A-6C show an exemplary embodiment of a stationary “hive” residential/commercial power device 300. The stationary power device 300 would be used for stored energy to power a home or office. There may be different sizes depending on needs, including a smaller device 301 (which accommodates up to 7 pods 100), and a larger device 302 (which accommodates up to 13 pods 100). The worker pods 100 would be inserted and removed as needed, and an electronic display 305 would indicate which worker pod 100 is weak or inoperable. The stationary power device 300 could be paired with a home's solar systems and hybrid inverter, that is tied to the home or office's breaker box. The number of pods 100 needed can scale to a user's needs. Each stationary device 300 can hold a plurality of worker pods 100, and multiple devices 300 are chainable to provide greater energy output to a residence or business. A device 300 is generally similar to a Tesla or LG Powerwall, but with interchangeable and customizable energy storage capacity. Exemplary specifications, dimensions, and tolerances of the stationary device 300 are shown and presented in TABLE 4.

TABLE 4
STATIONARY HOME/BUSINESS POWER DEVICE

Max Total Capacity: 13 kw (52 Volt/260 Amp Hour)
Min. Total Capacity: 7 kw (52 Volt/140 Amp Hour)
Battery Type: NMC (lithium nickel manganese cobalt oxide)
Nominal voltage: 52 v
Efficiency: 90%
Chainable: Yes, up to 9 addition Hives
Protection function: Over charge protection, Over discharge
protection, Over current protection, Temperature protection, Short
circuit protection
Discharge Current: 100 amp
Peak Discharge Current: 300 amp @ 5 sec
Discharge Cutoff Voltage: 35.75 v (Can be set)
Charge Current: <50 amp
Charge Voltage: 54.6 v (Can be set)
Charge temp: 0*C - 45*C (32 F - 113 F)
Discharge temp: −20*C - 65*C (−4F - 149F)
Storage temp: −20*C - 65*C (−4F - 149F)
Humidity: 5% < RH < 95%
Communication: CAN/RS484/RS232/Ethernet/Bluetooth
Certifications: CE/RoHS/UL (Cells)
Inner resistance: 60 mΩ Between positive and negative polar
When the environment temperature is higher than 45° C.,
pay attention to ventilation and heat rejection.

Finally, FIG. 7 shows an exemplary embodiment of an “apiary” utility/microgrid scale power device. The utility grid 400 is essentially the same as worker pod 100 or hive 300 but multiplied by a few thousand. The containers 401 can be customized to the needed capacity of energy storage. For example, 500 kWh would need 500 worker pods. 2 MWh would need 2000 pods. In one exemplary embodiment, a 40 foot container can produce −3.5 MWh of capacity (3500 pods). Any number of total pods is possible, and is directly dependent on the ultimate power desired. Each container 401 can be chained to other containers 401 to produce any total power level. A display 402 can indicate which one or more containers 401 may be underproducing power, allowing a user to closely examine if one or more pods 100 contained therein need to be replaced.

The worker pods 100 themselves may be charged up. The charging may be controlled by the device that the worker pod attaches to. For example, worker pods 100 may be attached to the 3K portable power device 200 charging 10 amp total (FIG. 5). The portable power device 200 will control the load sharing. All 3 may be plugged in, equal load charging, 3.3 amps each. Or set one is to be quick charge, 8 amps to 1 Worker Pod, 1 amp to the others. The same can be done with the Home Hive Energy Storage 300 (FIG. 6), and Apiary 400 (FIG. 7). Other sources of power charge are possible, such as renewable sources from solar, wind, etc.

Another exemplary embodiment of the individual unit power pod 500 is shown in FIGS. 8-11. FIGS. 8A, 9A, 10A, and 11A show a surface view of a single power pod 500, and FIGS. 8B, 9B, 10B, 11B show a ghost view of the surface of the single power pod 500 and a dashed line outline of the internal shape and connection structures, as will be described in detail below. As shown in FIGS. 8-11, a single power pod 500 has a front end 501 and a rear end 502. Front end 501 has a surface cap 503 with a flattened top surface 504.

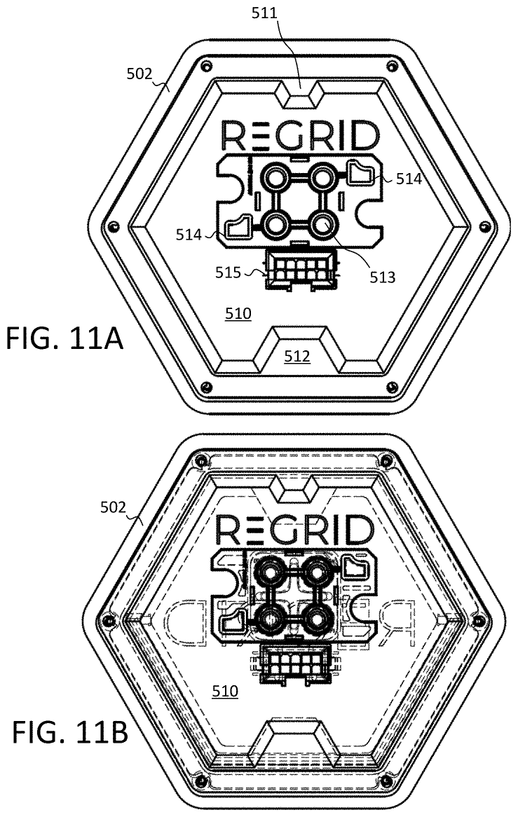

FIG. 11 shows the rear end 502 of the single power pod 500. The rear end 502 has a pod interface 510 with a flattened surface containing a number of features to connect the power within the power pod 500 to the outside recipients. These features are shown here and will be described in more detail with respect to their connections with a pod receptacle 550. Small projection 511 and large projection 512, along with a pair of opposing projections 514 mate with their counterparts on the pod receptacle 550. Female receptacles 513 mate with male projections on the pod receptacle 550. Electrical connections 515 mate with counterpart electrical connections on the pod receptacle 550.

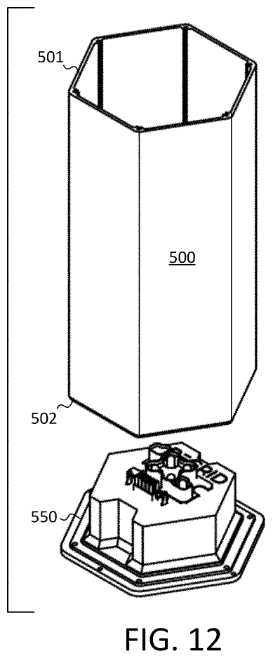

FIG. 12 shows an exploded view of the body shell of a single worker pod 500 atop a pod receptacle 550. The surface cap 503 is not shown for sake of simplicity. The pod receptacle 550 is designed to fit within a bottom cavity positioned within the rear end 502 of the single power pod 500.

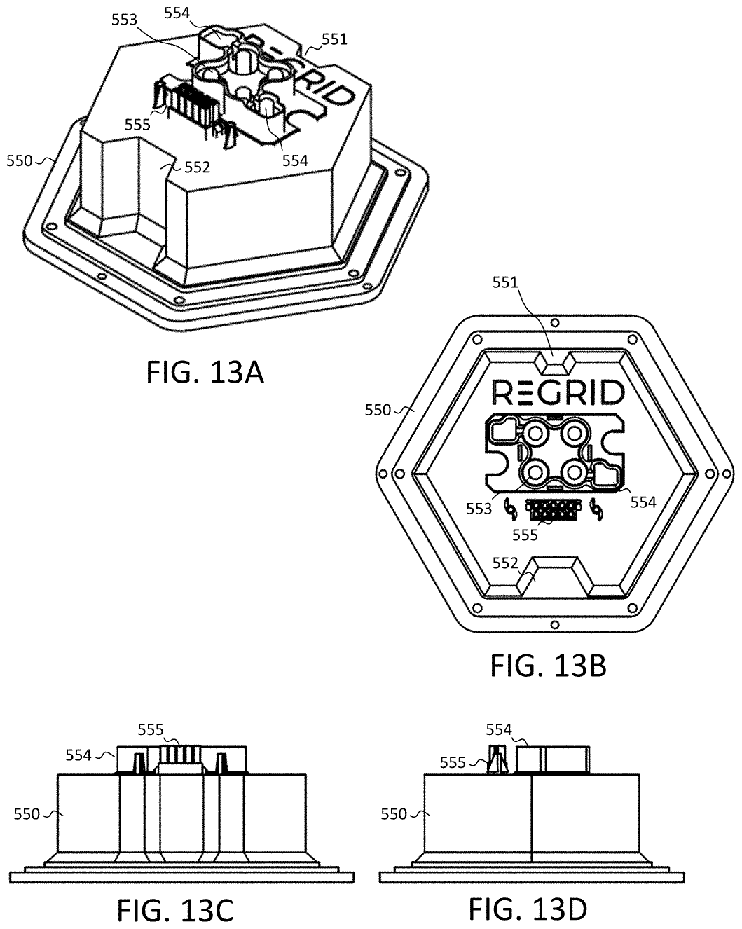

FIGS. 13A, 13B, 13C, and 13D show a side perspective, top, front, and side views, respectively, of a pod receptacle 550, according to an exemplary embodiment of the present subject disclosure. The pod receptacle 550 contains features which assist in ensuring proper mating with the rear side interface 510 of the single power pod 500. A smaller cavity 551 mates with the small projection 511 on the rear side of the pod 500. A larger cavity 552 mates with the larger projection 512 on the rear side of the pod 500. A pair of shaped cavities 554 mate with a pair of shaped projections 514 on the single power pod 500. One or more male projections 553 (four shown in the figures) mate with counterpart female receptacles 513 on the power pod 500. Male electrical projections 555 mate with the counterpart female electrical receptacles 515 on the power pod 500. The mating of the various components on the pod receptacle 550 with the counterpart component on the rear end interface 510 of the single power pod 500 ensures that there is a specific connection made to transfer power and enable the power unit device 500.

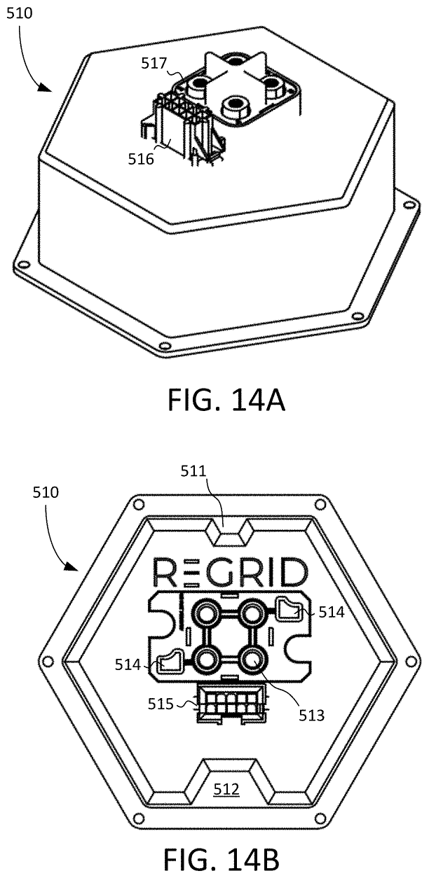

FIG. 14A shows a top perspective view, and FIG. 14B show a bottom view of the rear end interface portion 510 of the power pod 500. The features on the bottom surface of the rear end portion 510, as shown in FIG. 14B, are those described in FIG. 11A, but without the shell of the pod 500.

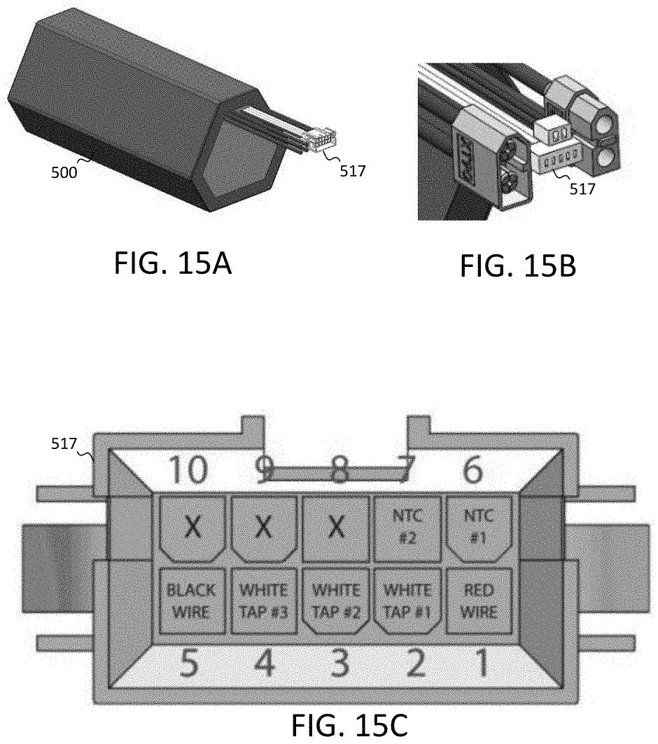

FIGS. 15A-15C show various examples of the connection of the battery, with 12.8 V and 90 Ah. The exemplary battery used is the LiFePO4 battery. FIGS. 15A-15C show an exemplary electrical connection of the battery. The single unit pod 500 includes an electrical connector 517 having a plurality of connections with differing functions, including NTC #1, NTC #2, Black Wire, Red Wire, and White Tap #1, #2, and #3. Other combinations are also possible, and within the purview of the present subject disclosure.

Specific features of this battery include, but are not limited to, as well as presented in TABLE 5:
Longer Cycle Life: Offers up to 20 times longer cycle life and five times longer float/calendar life than lead acid battery, helping to minimize replacement cost and reduce total cost of ownership.
Lighter Weight: About 40% of the weight of a comparable lead acid battery. A “drop in” replacement for lead acid batteries.
Higher Power: Delivers twice power of lead acid battery, even high discharge rate, while maintaining high energy capacity.
Wider Temperature Range: −20 C˜60 C.
Superior Safety: Lithium Iron Phosphate chemistry eliminates the risk of explosion or combustion due to high impact, overcharging or short circuit situation.

TABLE 5
FEATURES AND SPECIFICATION FOR LiFePO4 BATTERY

| | |
|---|---|
| Cell | |
| Type | LiFePO4 Battery |
| Cell Model | LF32135-15AH |
| Nominal Capacity | 15 Ah @0.5 C 100% DOD |
| Nominal Voltage | 3.2 V |
| Approx. Dimensions | L140.3x_33.3 mm |
| Approx. Weight | 267 gs |
| Electrical Characteristics | |
| Nominal Voltage | 12.8V |
| Nominal Capacity | 90 Ah |
| Minimum Capacity | 90 Ah |
| Energy | 1152 Wh |
| Cycle Life | >2000 cycles @0.5 C 100% DOD |
| Months Self Discharge | <3% |
| Efficiency of Charge | 100% @0.5 C |
| Efficiency of Discharge | 96-99% @0.5 C |
| BMS Functions | Over charge, over discharge, |
| | over current, short circuit and |
| | temperature protection |

Standard Charge and Discharge

| | |
|---|---|
| Charge Voltage | 10-14.6 V |
| Charge Mode | 0.2 C to 14.6 V, then |
| | 14.6 V,charge current to 0.02 C |
| | (CC/CV) |
| Charge Current | 10 A |
| Max. Charge Current | 45 A |
| Max Continuous | |
| Discharge Current | 90 A |
| Peak Discharge Current | 180 A 1-3S |
| Discharge Cut-off Voltage | 10 V ± 0.5 V |
| Environmental | |
| Charge Temperature | 0 C to 55 C (32 F to 131 F) @60 ± |
| | 25% Relative Humidity |
| Discharge Temperature | −20 C to 60 C (−4 F to 140 F) @60 ± |
| | 25% Relative Humidity |
| Storage Temperature | 0 C to 45 C (32 F to 113 F) @60 ± |
| | 25% Relative Humidity |
| IP Class | IP30 |
| Mechanical | |
| Packing | PVC |
| Approx. Dimensions | L295 ± 2 mmxW123 ± 2 mm |
| Approx. Weight | 7.5 kgs |
| Terminal Type | 200 mm |
| Terminal Type | 15060106-1 OP NTC 10 KΩ B = 3435 |
| | 200 mm Positive to |

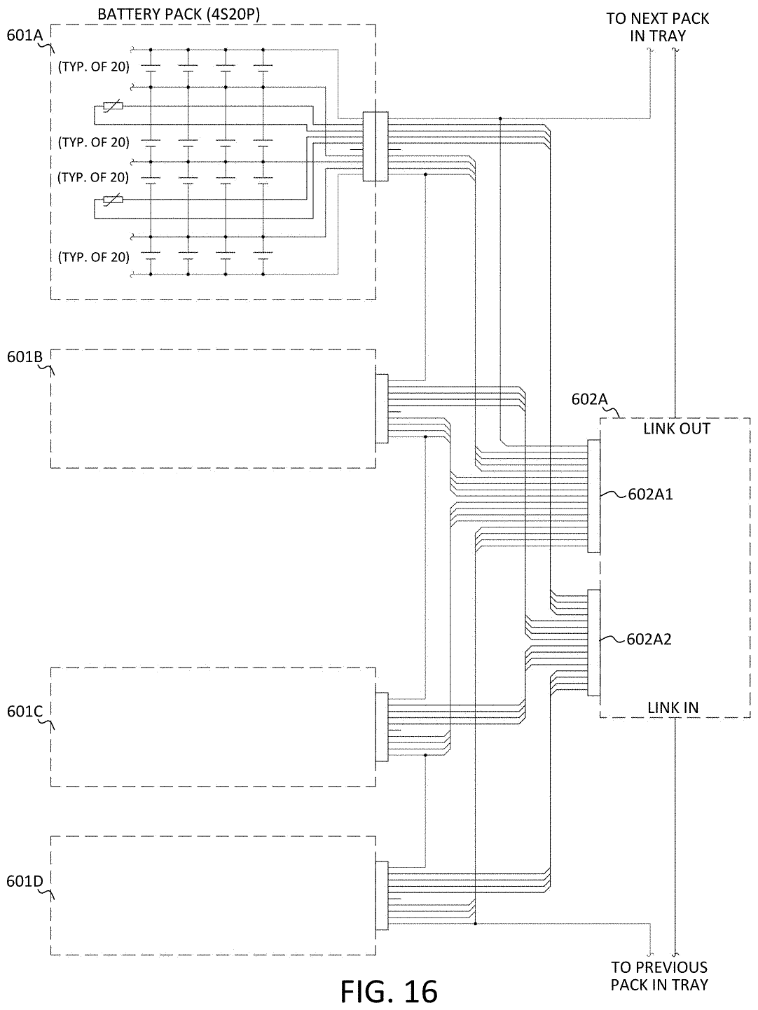

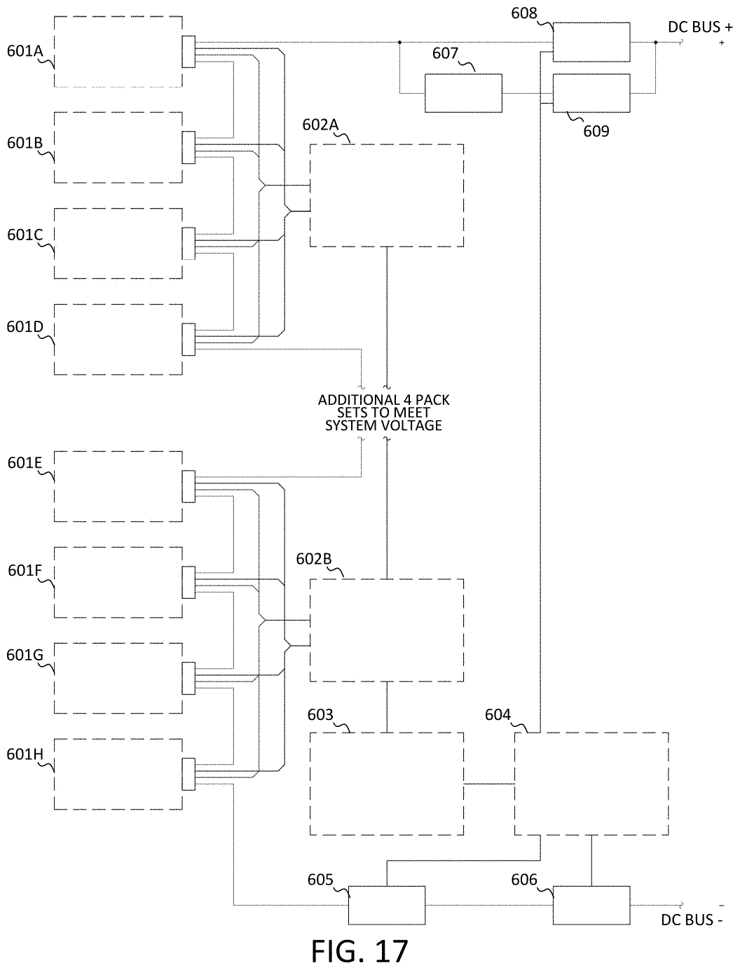

FIGS. 16-17 show exemplary embodiments of the system architecture for the commercial and utility scales, respectively. This shows the wiring for the battery cell balancing and power management. An array of battery packs including battery packs 601A, 601B, 601C, and 601D communicate with cell interface module 602A. Cell interface module 602A may have battery cells 602A1 and temperature sensors 602A2, and controls the balancing and monitors the temperature sensor of each modular battery. Further, another array of battery packs 601E, 601F, 601G, 601H communicate with cell interface module 602B. Additional 4 packs of batteries may be combined to meet system voltage. The cell interface 62B communicates with stack controller 603, which communicates with power interface 604, and manages the power from all modular batteries. A current shunt 605 and main contractor 606 communicate with the power interface 604, and result in the DC Bus negative. On the DC Bus positive end, a current limiter 607 communicates with a pre-charge contractor 609 and main contractor 608 to output DC Bus positive.

Another exemplary embodiment of the present subject disclosure is a hexagonal cabinet style power housing 700, as shown in FIGS. 18A-18D. The housing 700 has a top portion 701, a base portion 702, and a central cabinet that has one or more doors 705 that allow access therein. When the doors 705 are open, one or more drawers 706 may be pulled out, revealing a tray with an array of single pods 500. This cabinet style power housing 700 may be weather proof, and suitable for indoor or outdoor locations.

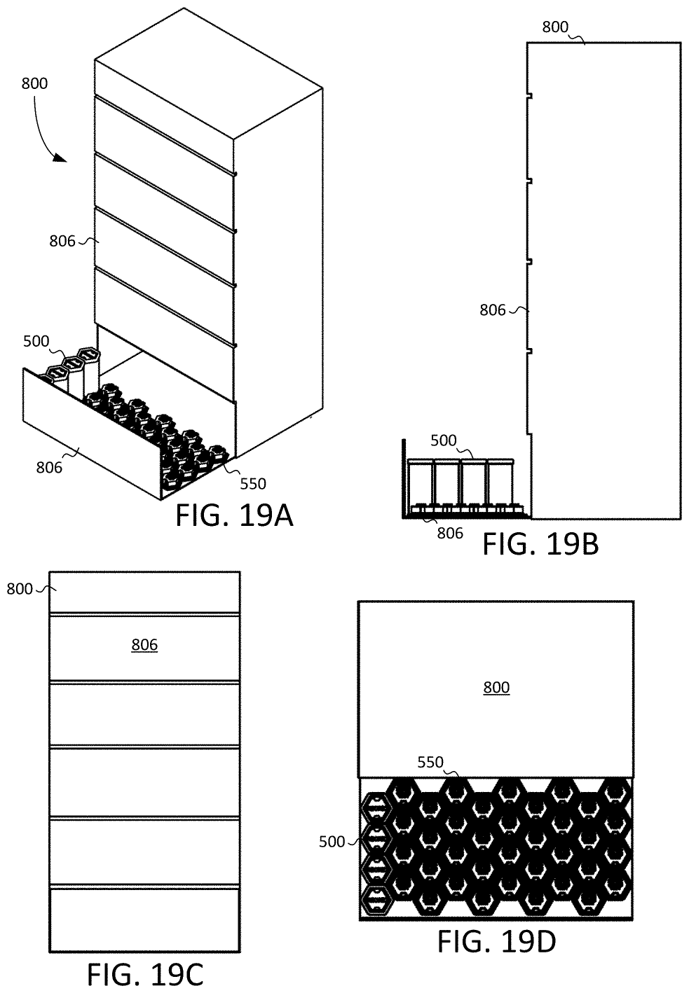

FIGS. 19A, 19B, 19C, and 19D show side perspective, side, front, and top views of a square cabinet style power housing 800, with six pull out drawers 806. As shown in the one drawer 806 pulled out, a plurality of power pods 500 may be positioned atop the receptacles 550 positioned on the bottom side of each of the pull out drawers 806.

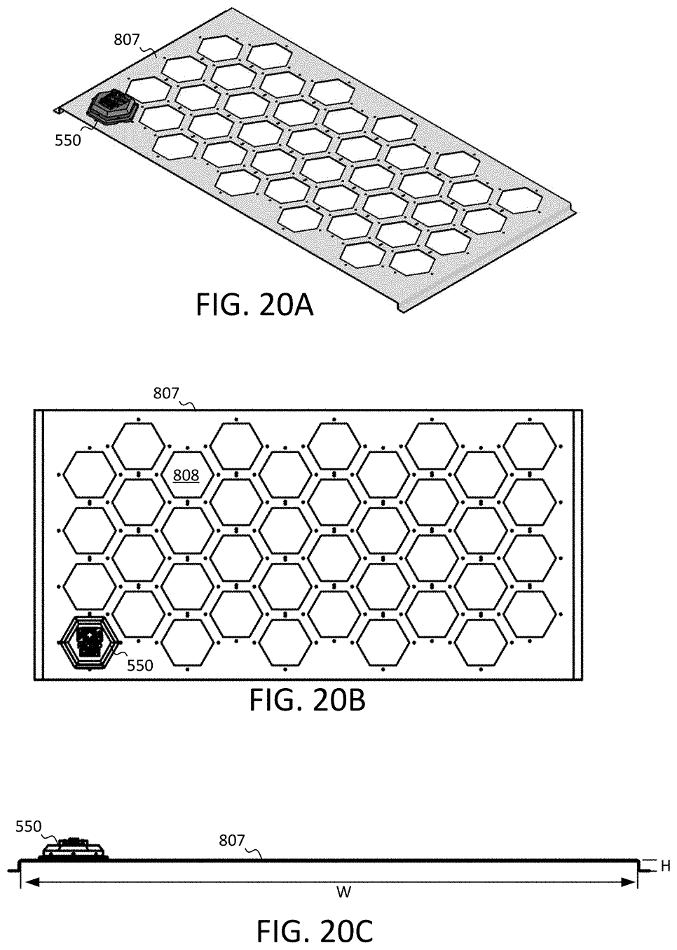

As shown in FIG. 19, pull out drawers 806 contain an array of power pods 500 positioned at even intervals. This may be achieved by providing an arrangement tray 807 with pre-cut out shaped positions 808 with the pod receptacle 550 positioned therein. The tray 807 has a given height H (see FIG. 20C) and width W that allow it to fit perfectly within the drawer 806, and allow the receptacle 550 to be positioned therein. The pod receptacle openings 808 in the embodiment shown in FIG. 20 allows for some space between each of the power pods 500. This allows for ease of insertion and removal of the individual pods 500 upon the pod receptacle 550.

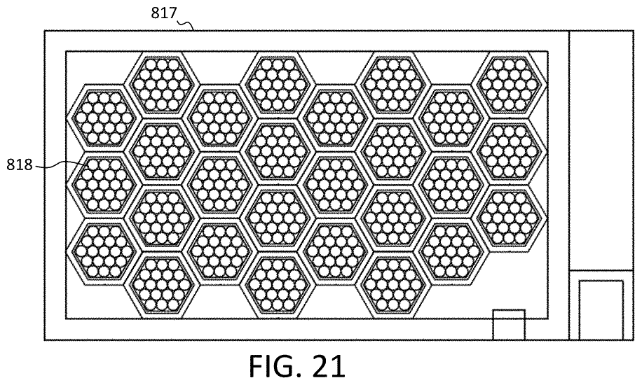

FIG. 21 shows an alternative arrangement tray design 817 that has receptacle pod apertures 818 that are adjacent each other, with no gap between the power pods 500. Such a design is suitable for when it is desired to maximize space usage to produce a larger power source.

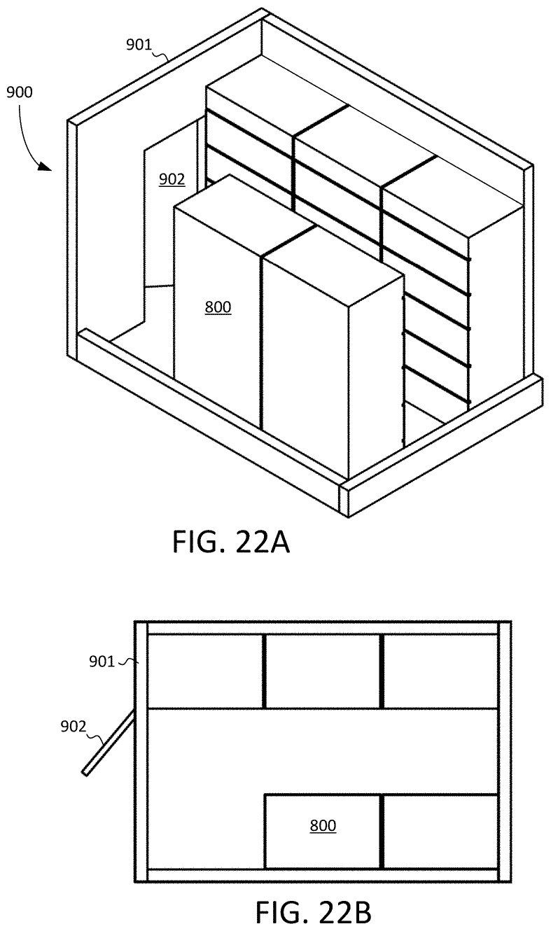

FIGS. 22A and 22B show a side perspective, and top view of a 1 MWh power grid layout, using the power cabinets 800 shown in FIG. 19. A series of five (5) power cabinets 800 are positioned inside a containment structure 901. Each of the individual pods 500, positioned within each drawer 806, within each power cabinet 800, may be readily accessible and replaceable, when inside the containment structure 901, via access door 902.

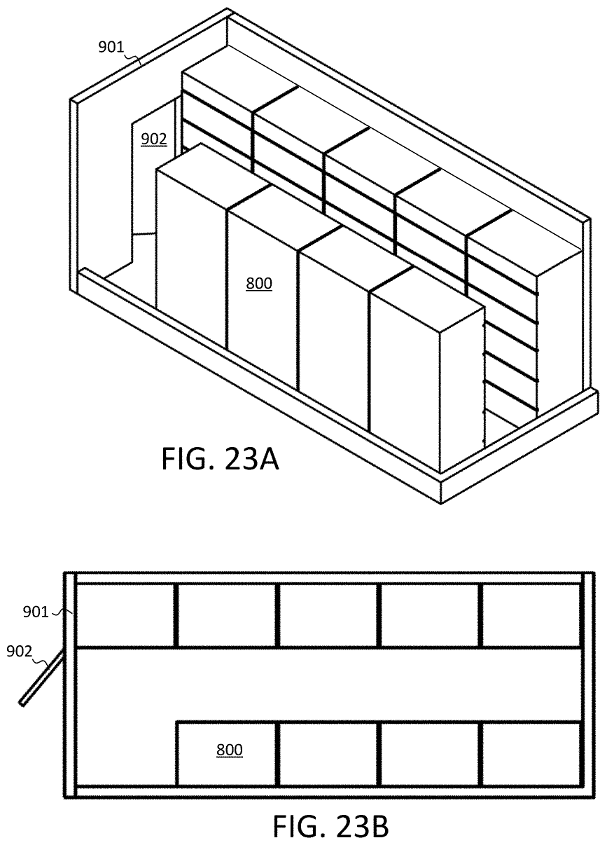

FIGS. 23A and 23B show a side perspective, and top view of a 2 MWh power grid layout, using the power cabinets 800 shown in FIG. 19. A series of nine (9) power cabinets 800 are positioned inside a containment structure 901. Each of the individual pods 500, positioned within each drawer 806, within each power cabinet 800, may be readily accessible and replaceable, when inside the containment structure 901, via access door 902.

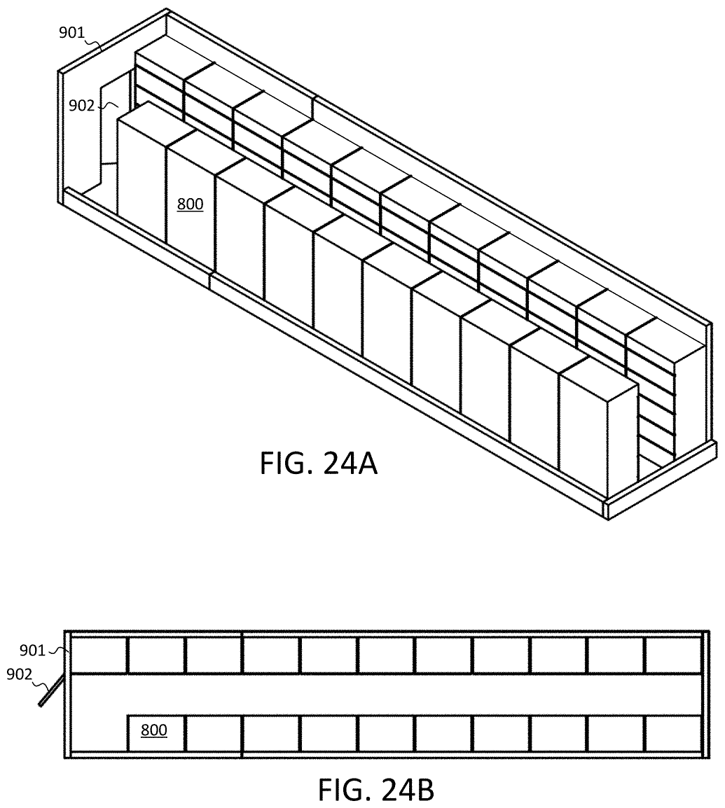

Finally, FIGS. 24A and 24B show a side perspective, and top view of a 5 MWh power grid layout, using the power cabinets 800 shown in FIG. 19. A series of twenty-one (21) power cabinets 800 are positioned inside a containment structure 901. Each of the individual pods 500, positioned within each drawer 806, within each power cabinet 800, may be readily accessible and replaceable, when inside the containment structure 901, via access door 902.

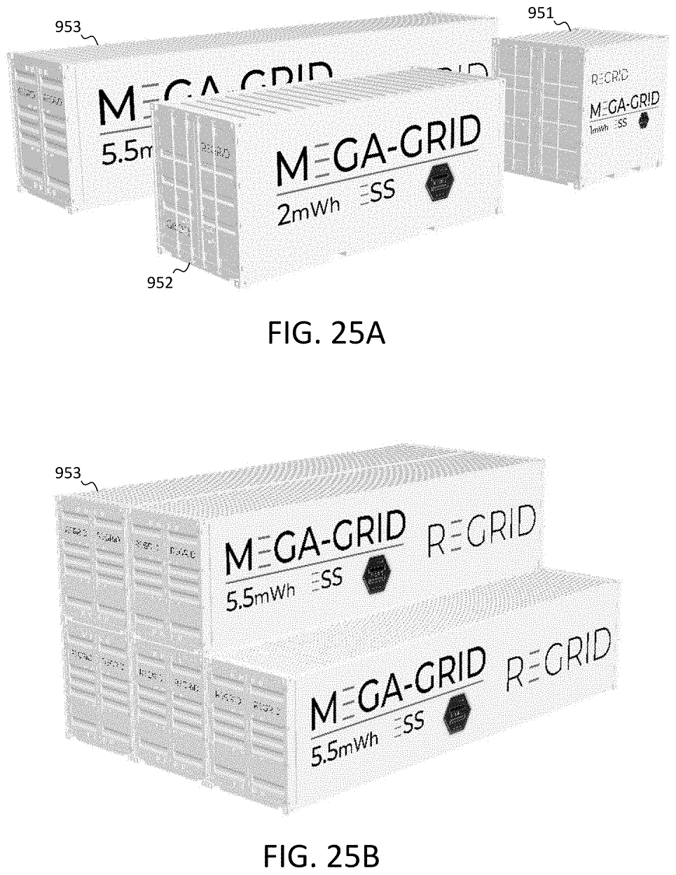

Using the individual cabinets 800, shown and described with respect to FIG. 19, a series of pre-packaged and ready to ship containment packages may be created. For example, as shown in FIG. 25A, containment package 951 is capable of producing 1 MWh, containment package 952 is capable of producing 2 MWH, and containment package 953 is capable of producing 5.5 MWh.

The containment packages are square and rectangular so they are easy to stack and ship, as needed. A series of large containment packages 953, each producing 5.5 MWh, are able to be stacked together for storage, shipping, or creating cumulative power.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A power source, comprising:
a housing having an interior and an exterior;
a plurality of batteries positioned within the interior of the housing;
a power port positioned on the exterior of the housing and used to derive power from the batteries to power an individual device; and
a connection port positioned on the exterior of the housing and used to provide power to an additive power source.

2. The power source in claim 1, wherein the batteries in the plurality of batteries are positioned in series.

3. The power source in claim 1, wherein the batteries in the plurality of batteries are positioned in parallel.

4. The power source in claim 1, wherein the housing exterior has a hexagonal shape.

5. The power source in claim 1, wherein the housing includes a handle.

6. The power source in claim 1, wherein batteries produce about 50 v.

7. The power source in claim 1, wherein batteries produce about 20 ah.

8. A portable power source, comprising:
a portable shell having an input chamber for receiving a modular power source, wherein the modular power source comprises:
a housing; and
a plurality of batteries positioned within the housing;
a power port positioned on the shell and used to provide power from the modular power source.

9. The portable power source in claim 8, wherein the input chamber comprises a plurality of input chambers.

10. The portable power source in claim 9, wherein the modular power source comprises a plurality of modular power sources.

11. The portable power source in claim 10, comprising three input chambers for receiving three modular power sources.

12. The portable power source in claim 8, wherein 3000 w are produced.

13. The portable power source in claim 8, wherein the batteries in the plurality of batteries are positioned in series.

14. The portable power source in claim 8, wherein the batteries in the plurality of batteries are positioned in parallel.

15. The portable power source in claim 8, wherein the housing has a hexagonal shape.

16. The portable power source in claim 8, wherein the shell includes a handle.

17. The portable power source in claim 8, wherein the shell includes a display to indicate whether the modular power source is operational.

18. A power source, comprising:
a stationary receiving device having a plurality of input chambers for receiving a plurality of modular power sources, wherein the modular power source comprises:
a housing; and
a plurality of batteries positioned within the housing;
a power port positioned on the stationary receiving device and used to provide cumulative power from the plurality of modular power sources.

19. The power source in claim 18, wherein the housing has a hexagonal shape.

20. The power source in claim 18, wherein the stationary receiving device includes a display to indicate whether each of the modular power sources is operational.
